(19) United States
(12) Patent Application Publication
(10) Pub. No.: US 2023/0259789 A1
(43) Pub. Date: Aug. 17, 2023

(54) FEDERATED LEARNING FOR DEEP NEURAL NETWORKS IN A WIRELESS COMMUNICATION SYSTEM

(71) Applicant: Google LLC, Mountain View, CA (US)

(72) Inventors: Jibing WANG, Mountain View, CA (US); Erik STAUFFER, Mountain View, CA (US)

(21) Appl. No.: 18/015,520

(22) PCT Filed: Jun. 28, 2021
(86) PCT No.: PCT/US2021/039408

§ 371 Date: Jan. 10, 2023

Related U.S. Application Data
(60) Provisional application No. 63/050,733, filed on Jul. 10, 2020.

(51) Int. Cl. G06N 3/098

(52) U.S. Cl. CPC G06N 3/098

(57) ABSTRACT

Aspects describe federated learning for deep neural networks, DNNs, in a wireless communication system. A network entity directs (610) each user equipment, UE, in a set of UEs to form, using an initial machine-learning (ML) configuration, a respective deep neural network, DNN, that processes wireless network communications. The network entity requests (620), from each UE in the set of UEs, respective updated ML information generated by the respective UE using a training procedure and local input data. The network entity then receives (640), from at least some UEs in the set of UEs, the respective updated ML information determined by the respective UE. The network entity identifies (645) a subset of UEs in the set of UEs and determines (650) a common ML configuration for the subset of UEs. The network entity then directs (655) each UE in the subset of UEs to form an updated DNN using the common ML configuration.

### BACKGROUND

Evolving wireless communication systems utilize increasingly complex architectures as a way to provide more performance relative to preceding wireless communication systems. As one example, fifth generation new radio (5G NR) wireless technologies transmit data using higher frequency ranges, such as the above-6 Gigahertz (GHz) band, to increase data capacity. However, transmitting and recovering information using these higher frequency ranges poses challenges. To illustrate, higher frequency signals are more susceptible to multipath fading, scattering, atmospheric absorption, diffraction, interference, and so forth, relative to lower frequency signals. As another example, hardware capable of transmitting, receiving, routing, and/or otherwise using these higher frequencies can be expensive and complicated to incorporate into devices. With recent advancements in wireless communication systems and technology, new approaches may be available to produce devices capable of wirelessly communicating using these higher frequency ranges.

### SUMMARY

This document describes techniques and apparatuses for federated learning for deep neural networks (DNNs) in a wireless communication system. A network entity directs each user equipment (UE) in a set of UEs to form, using an initial machine-learning (ML) configuration, a respective deep neural network (DNN) that processes wireless network communications. The network entity requests each UE in the set of UEs to report updated ML information about the respective DNN by generating the updated ML information using a training procedure and input data local to the respective UE. The network entity then receives, from at least some UEs in the set of UEs, the respective updated ML information determined by the respective UE. The network entity identifies a subset of UEs in the set of UEs with one or more common characteristics and determines, using the respective updated ML information from each UE in the subset of UEs, a common ML configuration. The network entity then directs each UE in the subset of UEs to form, using the common ML configuration, an updated DNN that processes the wireless network communications.

In aspects, a user equipment (UE) receives directions from a network entity to form, using an initial machine-learning (ML) configuration, a deep neural network (DNN) that processes wireless network communications. The UE receives, from a network entity, a request to report updated ML information for the DNN based on a training process and generates the updated ML information by performing the training process using data local to the UE. The UE transmits, to the network entity, a message that indicates the updated ML information. The UE receives, from the network entity, an indication to update the DNN using a common ML configuration and then updates the DNN using the common ML configuration.

The details of one or more implementations of federated learning for DNNs in a wireless communication system are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of federated learning for deep neural networks (DNNs) in a wireless communication system are described below. The use of the same reference numbers in different instances in the description and the figures indicate similar elements:

FIG. 1 illustrates an example environment in which various aspects of federated learning for DNNs in a wireless communication system can be implemented;

FIG. 2 illustrates an example device diagram of devices that can implement various aspects of federated learning for DNNs in a wireless communication system;

FIG. 3 illustrates an example device diagram of a device that can implement various aspects of federated learning for DNNs in a wireless communication system;

FIG. 4 illustrates an example operating environment in which multiple deep neural networks are utilized in a wireless communication system in accordance with aspects of federated learning for DNNs in a wireless communication system;

FIG. 5 illustrates an example of generating multiple neural network formation configurations in accordance with aspects of federated learning for DNNs in a wireless communication system;

FIG. 6 illustrates an example transaction diagram between various network entities that implement federated learning for DNNs in a wireless communication system;

FIG. 7 illustrates a first example method that can be used to implement aspects of federated learning for DNNs in a wireless communication system; and

FIG. 8 illustrates a second example method that can be used to implement aspects of federated learning for DNNs in a wireless communication system.

### DETAILED DESCRIPTION

In conventional wireless communication systems, transmitter and receiver processing chains include numerous operations. For instance, a channel estimation block in the processing chain estimates or predicts how a transmission environment distorts a signal propagating through the transmission environment. As another example, channel equalizer blocks reverse the distortions on a received signal identified by the channel estimation block. These operations often become more complicated when processing higher frequency ranges, such as 5G frequencies in the above-6 GHz range. For instance, transmission environments add more distortion to the higher frequency ranges relative to lower frequency ranges, thus making information recovery more complex. As another example, the hardware added to a device for processing the higher frequency ranges can potentially increase the costs and complexity of building the device.

Deep neural networks (DNNs) provide solutions for performing various types of operations, such as processing communications transmitted between devices in a wireless communication system. To illustrate, by training a DNN on transmitter and/or receiver processing chain operations, the DNN can replace the conventional operations in a variety of ways, such as by replacing some or all of the conventional processing blocks used in end-to-end processing of wireless communication signals, replacing individual processing chain blocks, etc. Dynamic reconfiguration of a DNN, such as by modifying various architecture configurations (e.g., number of layers, layer processing algorithms, down-sampling configurations) and parameter configurations (e.g., coefficients or weights, layer connections, kernel sizes), also provides an ability to adapt how the DNNs process the wireless communications based on changing operating conditions.

Generally, machine-learning (ML) algorithms, such as DNNs, learn how to process input data and transform the input data to generate an output. The ML algorithms receive processing feedback (e.g., feedback that indicates the accuracy, or inaccuracy, of the generated output) and modify various architecture and parameter configurations of the ML algorithm to improve the accuracy and quality of the generated output. In some aspects, an ML controller or manager generates different ML configurations of the ML algorithm based on different operating conditions. To illustrate, the ML controller generates different ML configurations for a DNN that processes wireless communications based on variations in signal or link quality parameters, UE capabilities, timing information, modulation coding schemes (MCS), and so forth. This enables the ML controller to dynamically modify the DNN based on current operating conditions and improve an overall performance (e.g., higher processing resolution, faster processing, lower bit errors, improved signal quality, reduced latency) of the wireless communications transmitted through the wireless network.

Federated learning corresponds to a distributed training mechanism for a machine-learning algorithm. To illustrate, an ML controller selects a baseline ML configuration and directs multiple devices to form and train an ML algorithm using the baseline ML configuration. The ML controller then receives and aggregates training results from the multiple devices to generate an updated ML configuration for the ML algorithm. As one example, the multiple devices each report learned parameters (e.g., weights or coefficients) generated by the ML algorithm while processing their own particular input data, and the ML controller creates an updated ML configuration by averaging the weights or coefficients to create an updated ML configuration. As another example, the multiple devices each report gradient results, based on their own individual input data, to the ML controller that indicate an optimal ML configuration based on function processing costs (e.g., processing time, processing accuracy), and the ML controller averages the gradients. In some aspects, the multiple devices report learned ML architecture updates and/or changes from the baseline ML configuration. The terms federated learning, distributed training, and/or distributed learning may be used interchangeably.

By reporting learned weights/coefficients, gradients, or ML architectures of the ML algorithm, rather than their particular input data, the devices communicate learned results without exposing the input data. This protects the privacy of each device and provides learned ML information to the ML controller. Because multiple devices train and report results based on their own input data, federated learning increases an amount of training performed on the ML algorithm and improves a resultant ML configuration generated by the ML controller through aggregation. With reference to DNNs that process wireless communication, this also improves the overall performance of processing the wireless communications and/or the wireless communications transmitted in a wireless network.

Example Environment

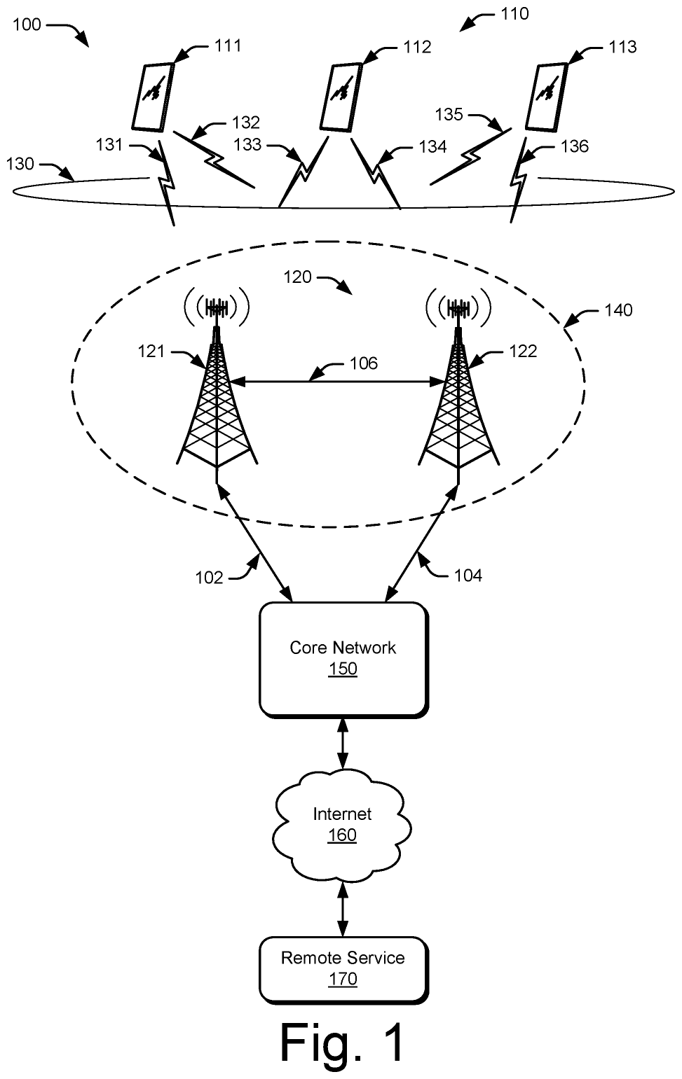

FIG. 1 illustrates an example environment 100, which includes multiple user equipment 110 (UE 110), illustrated as UE 111, UE 112, and UE 113. Each UE 110 can communicate with one or more base stations 120 (illustrated as base stations 121 and 122) through one or more wireless communication links 130 (wireless link 130), illustrated as wireless link 131, wireless link 132, wireless link 133, wireless link 134, wireless link 135, and wireless link 136, respectively. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, and the like, or any combination thereof.

The base stations 120 communicate with the user equipment 110 using the wireless links 130, which may be implemented as any suitable type of wireless link. The wireless links 130 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 130 may be aggregated in a carrier aggregation or multi-connectivity technology to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN or NR RAN). The base stations 121 and 122 in the RAN 140 are connected to a core network 150. The base stations 121 and 122 connect, at interface 102 and interface 104, respectively, to the core network 150 through an NG2 interface for control-plane signaling and using an NG3 interface for user-plane data communications when connecting to a 5G core network, or using an S1 interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at interface 106, to exchange user-plane and control-plane data. The UE 110 may connect, via the core network 150, to public networks, such as the Internet 160, to interact with a remote service 170. The remote service 170 represents the computing, communication, and storage devices used to provide any of a multitude of services, including interactive voice or video communication, file transfer, streaming voice or video, and other technical services implemented in any manner such as voice calls, video calls, website access, messaging services (e.g., text messaging or multi-media messaging), photo file transfer, enterprise software applications, social media applications, video gaming, streaming video services, and podcasts.

Example Devices

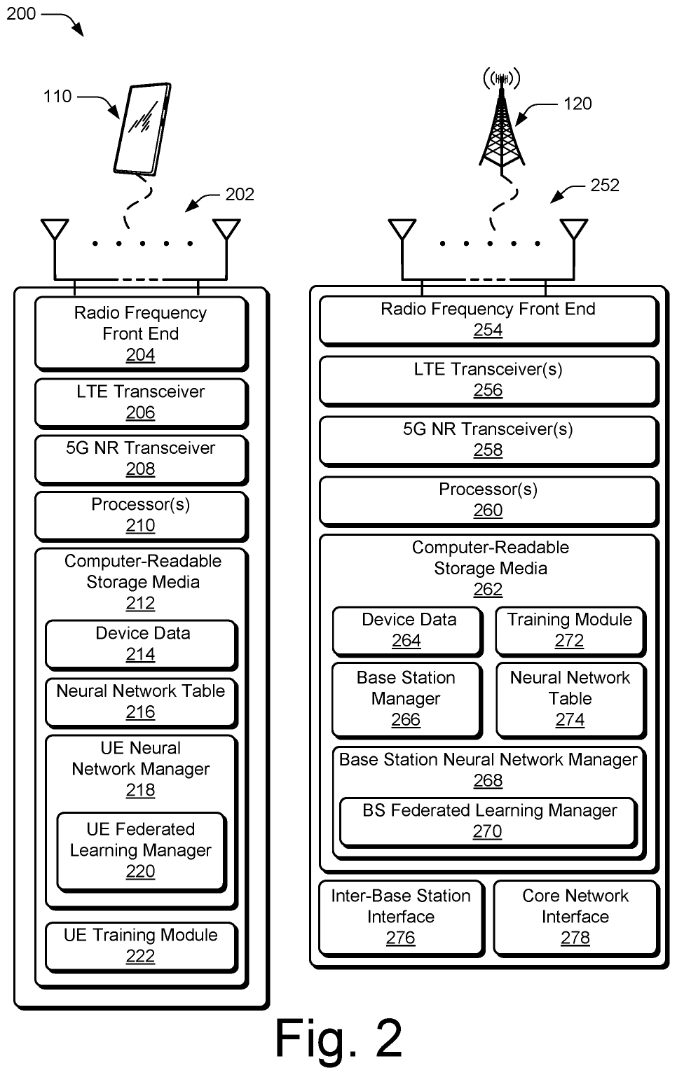

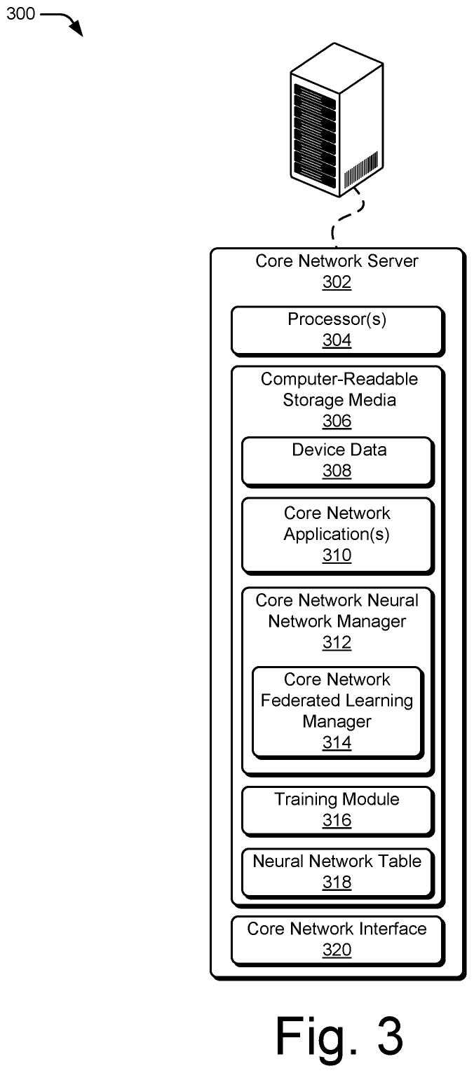

FIG. 2 illustrates an example device diagram 200 of the UE 110 and one of the base stations 120 that can implement various aspects of federated learning for DNNs in a wireless communication system. FIG. 3 illustrates an example device diagram 300 of a core network server 302 that can implement various aspects of federated learning for DNNs in a wireless communication system. The UE 110, the base station 120, and/or the core network server 302 may include additional functions and interfaces that are omitted from FIG. 2 or 3 for the sake of clarity.

The UE 110 includes antennas 202, a radio frequency front end 204 (RF front end 204), and a wireless transceiver (e.g., an LTE transceiver 206, and/or a 5G NR transceiver 208) for communicating with the base station 120 in the RAN 140. The RF front end 204 of the UE 110 can couple or connect the LTE transceiver 206, and the 5G NR transceiver 208 to the antennas 202 to facilitate various types of wireless communication. The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base station 120. By way of example and not limitation, the antennas 202 and the RF front end 204 can be implemented for operation in sub-gigahertz bands, sub-6 GHz bands, and/or above-6 GHz bands that are defined by the 3GPP LTE and 5G NR communication standards.

The UE 110 also includes processor(s) 210 and computer-readable storage media 212 (CRM 212). The processor 210 may be a single-core processor or a multiple-core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the UE 110. The device data 214 includes user data, multimedia data, beamforming codebooks, applications, neural network (NN) tables, neural network training data, and/or an operating system of the UE 110, some of which are executable by processor(s) 210 to enable user-plane data, control-plane information, and user interaction with the UE 110.

In aspects, the CRM 212 includes a neural network table 216 that stores various architecture and/or parameter configurations that form a neural network, such as, by way of example and not of limitation, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network table 216 includes any combination of neural network formation configuration elements (NN formation configuration elements), such as architecture and/or parameter configurations that can be used to create a neural network formation configuration (NN formation configuration) that includes a combination of one or more NN formation configuration elements that define and/or form a DNN. In some aspects, a single index value of the neural network table 216 maps to a single NN formation configuration element (e.g., a 1:1 correspondence). Alternatively, or additionally, a single index value of the neural network table 216 maps to an NN formation configuration (e.g., a combination of NN formation configuration elements). In some implementations, the neural network table includes input characteristics for each NN formation configuration element and/or NN formation configuration, where the input characteristics describe properties about the training data used to generate the NN formation configuration element and/or NN formation configuration as further described.

The CRM 212 may also include a user equipment neural network manager 218 (UE neural network manager 218). Alternatively, or additionally, the UE neural network manager 218 may be implemented in whole or part as hardware logic or circuitry integrated with or separate from other components of the UE 110. The UE neural network manager 218 accesses the neural network table 216, such as by way of an index value, and forms a DNN using the NN formation configuration elements specified by an NN formation configuration. This includes updating the DNN with any combination of architectural changes and/or parameter changes to the DNN as further described, such as a small change to the DNN that involves updating parameters and/or a large change that reconfigures node and/or layer connections of the DNN. In implementations, the UE neural network manager forms multiple DNNs to process wireless communications (e.g., downlink communications, uplink communications).

The UE neural network manager 218 includes a UE federated learning manager 220 that manages operations associated with providing updated ML information (e.g., learned ML parameters, learned ML architectures) about a neural network (e.g., a DNN) formed at the UE 110 to a federated learning manager at a network entity that aggregates updated ML information from multiple devices. While FIG. 2 shows the UE neural network manager 218 as including the UE federated learning manager 220, other aspects implement the UE neural network manager 218 separately from the UE federated learning manager 220. The UE federated learning manager 220 identifies requests from the base station 120 that indicate one or more conditions that specify when to train a DNN and/or when to report the updated ML information to the base station 120. To illustrate, the base station 120 indicates, to the UE federated learning manager 220, to perform a training procedure and/or to transmit updated ML information in response to identifying a trigger event (e.g., changing ML parameters, changing ML architectures, changing signal or link quality parameters, changing UE-location). As another example, the base station 120 indicates, to the UE federated learning manager 220, to perform the training procedure and/or to transmit updated ML information on a periodic basis. The UE federated learning manager 220 identifies the request and conditions received from the base station 120 and monitors for an occurrence of the condition(s). In some aspects, the UE federated learning manager 220 communicates with a UE training module 222 to trigger a training procedure and/or to extract updated ML information.

The CRM 212 includes the UE training module 222 that communicates with the UE federated learning manager 220. Alternatively, or additionally, the UE training module 222 may be implemented in whole or part as hardware logic or circuitry integrated with or separately from other components of the UE 110. In response to receiving an indication from the UE federated learning manager 220, the UE training module 222 supplies a DNN with known input data, such as input data stored as the device data 214. The UE training module 222 teaches and trains DNNs using known input data and/or by providing feedback to the ML algorithm. This includes training the DNN(s) offline (e.g., while the DNN is not actively engaged in processing the communications) and/or online (e.g., while the DNN is actively engaged in processing the communications).

In implementations, the UE training module 222 extracts updated ML information from a DNN and forwards the updated ML information to the UE federated learning manager 220. The extracted updated ML information can include any combination of information that defines the behavior of a neural network, such as node connections, coefficients, active layers, weights, biases, pooling, etc.

The device diagram for the base station 120, shown in FIG. 2, includes a single network node (e.g., a gNode B). The functionality of the base station 120 may be distributed across multiple network nodes or devices and may be distributed in any fashion suitable to perform the functions described herein. The base station 120 includes antennas 252, a radio frequency front end 254 (RF front end 254), one or more wireless transceivers (e.g., one or more LTE transceivers 256, and/or one or more 5G NR transceivers 258) for communicating with the UE 110. The RF front end 254 of the base station 120 can couple or connect the LTE transceivers 256 and the 5G NR transceivers 258 to the antennas 252 to facilitate various types of wireless communication. The antennas 252 of the base station 120 may include an array of multiple antennas that are configured in a manner similar to, or different from, each other. The antennas 252 and the RF front end 254 can be tuned to, and/or be tunable to, one or more frequency bands defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with the UE 110.

The base station 120 also includes processor(s) 260 and computer-readable storage media 262 (CRM 262). The processor 260 may be a single-core processor or a multiple-core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base station 120. The device data 264 includes network scheduling data, radio resource management data, beamforming codebooks, applications, and/or an operating system of the base station 120, which are executable by processor(s) 260 to enable communication with the UE 110.

CRM 262 also includes a base station manager 266. Alternatively, or additionally, the base station manager 266 may be implemented in whole or part as hardware logic or circuitry integrated with or separate from other components of the base station 120. In at least some aspects, the base station manager 266 configures the LTE transceivers 256 and the 5G NR transceivers 258 for communication with the UE 110, as well as communication with a core network, such as the core network 150.

CRM 262 also includes a base station neural network manager 268 (BS neural network manager 268). Alternatively, or additionally, the BS neural network manager 268 may be implemented in whole or part as hardware logic or circuitry integrated with or separate from other components of the base station 120. In at least some aspects, the BS neural network manager 268 selects the NN formation configurations utilized by the base station 120 and/or UE 110 to configure deep neural networks for processing wireless communications, such as by selecting a combination of NN formation configuration elements to form a DNN for processing wireless network communications. In some implementations, the BS neural network manager 268 receives feedback from the UE 110 and selects the NN formation configuration based on the feedback. Alternatively, or additionally, the BS neural network manager 268 receives neural network formation configuration directions from core network 150 through a core network interface 278 or an inter-base station interface 276 and forwards the NN formation configuration directions to UE 110.

The BS neural network manager 268 includes a base station federated learning manager 270 (BS federated learning manager 270) that manages federated learning of ML algorithms, such as one or more DNNs. The BS federated learning manager 270 indicates, to the UE 110, one or more update conditions (e.g., a trigger event, a periodicity) that specify when to perform a training procedure and/or when to report updated ML information to the BS federated learning manager 270. The BS federated learning manager 270 also receives updated ML information from a set of UEs and aggregates the updated ML information to determine a common ML configuration usable by a subset of UEs to form DNNs that process wireless communications. This can include determining a common ML configuration that indicates an update (e.g., a delta or a change) to an initial ML configuration used by the subset of UEs or a common ML configuration that indicates an (absolute) ML configuration that forms a new DNN. In some aspects, the BS federated learning manager 270 selects the subset of UEs based on common characteristics (e.g., estimated UE-location, UE capabilities) or common channel conditions (e.g., indicated by signal or link quality parameters). In aspects, the subset of UEs includes at least two UEs. Alternatively, or additionally, the BS federated learning manager 270 selects an initial ML configuration used by multiple devices for federated learning. Generally, a ML configuration corresponds to a NN formation configuration used to form a DNN, and can indicate any suitable type of information that defines the behavior of a neural network, such as node connections, coefficients, active layers, weights, biases, pooling, etc., and so forth.

The CRM 262 includes a training module 272 and a neural network table 274. In implementations, the base station 120 manages and deploys NN formation configurations to UE 110. Alternatively, or additionally, the base station 120 maintains the neural network table 274. The training module 272 teaches and/or trains DNNs using known input data. For instance, the training module 272 trains DNN(s) for different purposes, such as processing communications transmitted over a wireless communication system (e.g., encoding downlink communications, modulating downlink communications, demodulating downlink communications, decoding downlink communications, encoding uplink communications, modulating uplink communications, demodulating uplink communications, decoding uplink communications). This includes training the DNN(s) offline (e.g., while the DNN is not actively engaged in processing the communications) and/or online (e.g., while the DNN is actively engaged in processing the communications).

In implementations, the training module 272 extracts learned parameter configurations from the DNN to identify the NN formation configuration elements and/or NN formation configuration and then adds and/or updates the NN formation configuration elements and/or NN formation configuration in the neural network table 274. The extracted parameter configurations include any combination of information that defines the behavior of a neural network, such as node connections, coefficients, active layers, weights, biases, pooling, etc.

The neural network table 274 stores multiple different NN formation configuration elements and/or NN formation configurations generated using the training module 272. In some implementations, the neural network table includes input characteristics for each NN formation configuration element and/or NN formation configuration, where the input characteristics describe properties about the training data used to generate the NN formation configuration element and/or NN formation configuration. For instance, the input characteristics include, by way of example and not of limitation, any one or more of: power information, signal-to-interference-plus-noise ratio (SINK) information, channel quality indicator (CQI) information, reference signal receive quality (RSRQ), channel state information (CSI), Doppler feedback, frequency bands, BLock Error Rate (BLER), Quality of Service (QoS), Hybrid Automatic Repeat reQuest (HARQ) information (e.g., first transmission error rate, second transmission error rate, maximum retransmissions), latency, Radio Link Control (RLC), Automatic Repeat reQuest (ARQ) metrics, received signal strength (RSS), uplink SINK, timing measurements, error metrics, UE capabilities, BS capabilities, power mode, Internet Protocol (IP) layer throughput, end2end latency, end2end packet loss ratio, etc. Accordingly, the input characteristics include, at times, Layer 1, Layer 2, and/or Layer 3 metrics. In some implementations, a single index value of the neural network table 274 maps to a single NN formation configuration element (e.g., a 1:1 correspondence). Alternatively, or additionally, a single index value of the neural network table 274 maps to an NN formation configuration (e.g., a combination of NN formation configuration elements).

In implementations, the base station 120 synchronizes the neural network table 274 with the neural network table 216 such that the NN formation configuration elements and/or input characteristics stored in one neural network table are replicated in the second neural network table. Alternatively, or additionally, the base station 120 synchronizes the neural network table 274 with the neural network table 216 such that the NN formation configuration elements and/or input characteristics stored in one neural network table represent complementary functionality in the second neural network table (e.g., NN formation configuration elements for transmitter path processing in the first neural network table, NN formation configuration elements for receiver path processing in the second neural network table).

The base station 120 also includes an inter-base station interface 276, such as an Xn and/or X2 interface, which the base station manager 266 configures to exchange user-plane data, control-plane information, and/or other data/information between other base stations, to manage the communication of the base station 120 with the UE 110. The base station 120 includes a core network interface 278 that the base station manager 266 configures to exchange user-plane data, control-plane information, and/or other data/information with core network functions and/or entities.

In FIG. 3, the core network server 302 may provide all or part of a function, entity, service, and/or gateway in the core network 150. Each function, entity, service, and/or gateway in the core network 150 may be provided as a service in the core network 150, distributed across multiple servers, or embodied on a dedicated server. For example, the core network server 302 may provide all or a portion of the services or functions of a User-Plane Function (UPF), an Access and Mobility Management Function (AMF), a Serving Gateway (S-GW), a Packet Data Network Gateway (P-GW), a Mobility Management Entity (MME), an Evolved Packet Data Gateway (ePDG), and so forth. The core network server 302 is illustrated as being embodied on a single server that includes processor(s) 304 and computer-readable storage media 306 (CRM 306). The processor 304 may be a single-core processor or a multiple-core processor composed of a variety of materials, such as silicon, polysilicon, high-K dielectric, copper, and so on. CRM 306 may include any suitable memory or storage device such as random-access memory (RAM), static RAM (SRAM), dynamic RAM (DRAM), non-volatile RAM (NVRAM), read-only memory (ROM), hard disk drives, or Flash memory useful to store device data 308 of the core network server 302. The device data 308 includes data to support a core network function or entity, and/or an operating system of the core network server 302, which are executable by processor(s) 304.

CRM 306 also includes one or more core network applications 310, which, in one implementation, is embodied on CRM 306 (as shown). The one or more core network applications 310 may implement the functionality such as UPF, AMF, S-GW, P-GW, MME, ePDG, and so forth. Alternatively, or additionally, the one or more core network applications 310 may be implemented in whole or part as hardware logic or circuitry integrated with or separate from other components of the core network server 302.

CRM 306 also includes a core network neural network manager 312 that manages NN formation configurations used to form DNNs for processing communications transferred between the UE 110 and the base station 120. In aspects, the core network neural network manager 312 selects one or more NN formation configurations within the neural network table 318 to indicate the determined E2E ML configuration.

In some implementations, the core network neural network manager 312 analyzes various criteria, such as current signal channel conditions (e.g., as reported by base station 120, as reported by other wireless access points, as reported by UEs 110 (via base stations or other wireless access points)), capabilities of the base station 120 (e.g., antenna configurations, cell configurations, MIMO capabilities, radio capabilities, processing capabilities), capabilities of the UE 110 (e.g., antenna configurations, MIMO capabilities, radio capabilities, processing capabilities), and so forth. For example, the base station 120 obtains the various criteria and/or link quality indications (e.g., any one or more of: RSSI, power information, SINR, RSRP, CQI, CSI, Doppler feedback, BLER, HARQ, timing measurements, error metrics, etc.) during the communications with the UE and forwards the criteria and/or link quality indications to the core network neural network manager 312. The core network neural network manager selects, based on these criteria and/or indications, an ML configuration that improves the accuracy (e.g., lower bit errors, higher signal quality) of a DNN processing the communications. In some aspects, the core network neural network manager selects an initial ML configuration used by multiple devices for federated learning. The core network neural network manager 312 then communicates the E2E ML configuration to the base stations 120 and/or the UE 110, such as by communicating indices of the neural network table. In implementations, the core network neural network manager 312 receives UE and/or BS feedback from the base station 120 and selects an updated E2E ML configuration based on the feedback.

In some aspects, as shown in FIG. 3, the core network neural network manager 312 includes a core network federated learning manager 314, but alternate implementations implement the core network neural network manager 312 and the core network federated learning manager 314 as separate entities. In aspects, the core network federated learning manager 314 manages federated learning of DNNs. The core network federated learning manager 314 indicates, to the UE 110 and through the base station 120, when to initiate a training procedure and/or when to report updated ML information learned from the training procedure (e.g., offline training) and/or from processing wireless communications (e.g., online training). In aspects, the core network federated learning manager 314 indicates one or more update conditions (e.g., a trigger event, a periodicity) that specify when to initiate the training procedure and/or when to report updated ML information to the core network server 302 (and through the base station 120). The core network federated learning manager 314 also receives updated ML information from a set of UEs and aggregates the updated ML information to determine a common ML configuration usable by a subset of UEs to form DNNs that process wireless communications. In some aspects, the core network federated learning manager 314 selects the subset of UEs based on common UE characteristics (e.g., estimated UE-location, UE capabilities) or common channel conditions (indicated by signal or link quality parameters).

The CRM 306 includes a training module 316 and a neural network table 318. The training module 316 teaches and/or trains DNNs using known input data. For instance, the training module 316 trains DNN(s) to process different types of pilot communications transmitted over a wireless communication system. This includes training the DNN(s) offline and/or online. In implementations, the training module 316 extracts a learned NN formation configuration and/or learned NN formation configuration elements from the DNN and stores the learned NN formation configuration elements in the neural network table 318, such as an NN formation configuration that can be selected by the core network federated learning manager 314 and/or the core network neural network manager 312 as a common ML configuration learned from distributed training as further described. Thus, an NN formation configuration includes any combination of architecture configurations (e.g., node connections, layer connections) and/or parameter configurations (e.g., weights, biases, pooling) that define or influence the behavior of a DNN. In some implementations, a single index value of the neural network table 318 maps to a single NN formation configuration element (e.g., a 1:1 correspondence). Alternatively, or additionally, a single index value of the neural network table 318 maps to an NN formation configuration (e.g., a combination of NN formation configuration elements). The terms federated learning, distributed training, and/or distributed learning may be used interchangeably.

In some implementations, the training module 316 of the core network neural network manager 312 generates complementary NN formation configurations and/or NN formation configuration elements to those stored in the neural network table 216 at the UE 110 and/or the neural network table 274 at the base station 120. As one example, the training module 316 generates the neural network table 318 with NN formation configurations and/or NN formation configuration elements that have a high variation in the architecture and/or parameter configurations relative to medium and/or low variations used to generate the neural network table 274 and/or the neural network table 216. For instance, the NN formation configurations and/or NN formation configuration elements generated by the training module 316 correspond to fully connected layers, a full kernel size, frequent sampling and/or pooling, high weighting accuracy, and so forth. Accordingly, the neural network table 318 includes, at times, high-accuracy neural networks with the trade-off of increased processing complexity and/or time.

The neural network table 318 stores multiple different NN formation configuration elements generated using the training module 316. In some implementations, the neural network table includes input characteristics for each NN formation configuration element and/or NN formation configuration, where the input characteristics describe properties about the training data used to generate the NN formation configuration. For instance, the input characteristics can include a power information, SINR information, CQI, CSI, Doppler feedback, RSS, error metrics, etc.

The core network server 302 also includes a core network interface 320 for communication of user-plane data, control-plane information, and other data/information with the other functions or entities in the core network 150, base stations 120, or UE 110. In implementations, the core network server 302 communicates a common ML configuration (selected based on distributed learning/distributed training/federated learning) to the base station 120 using the core network interface 320. The core network server 302 alternatively or additionally receives feedback from the base stations 120 and/or the UE 110, by way of the base stations 120, using the core network interface 320.

Configurable Machine-Learning Modules

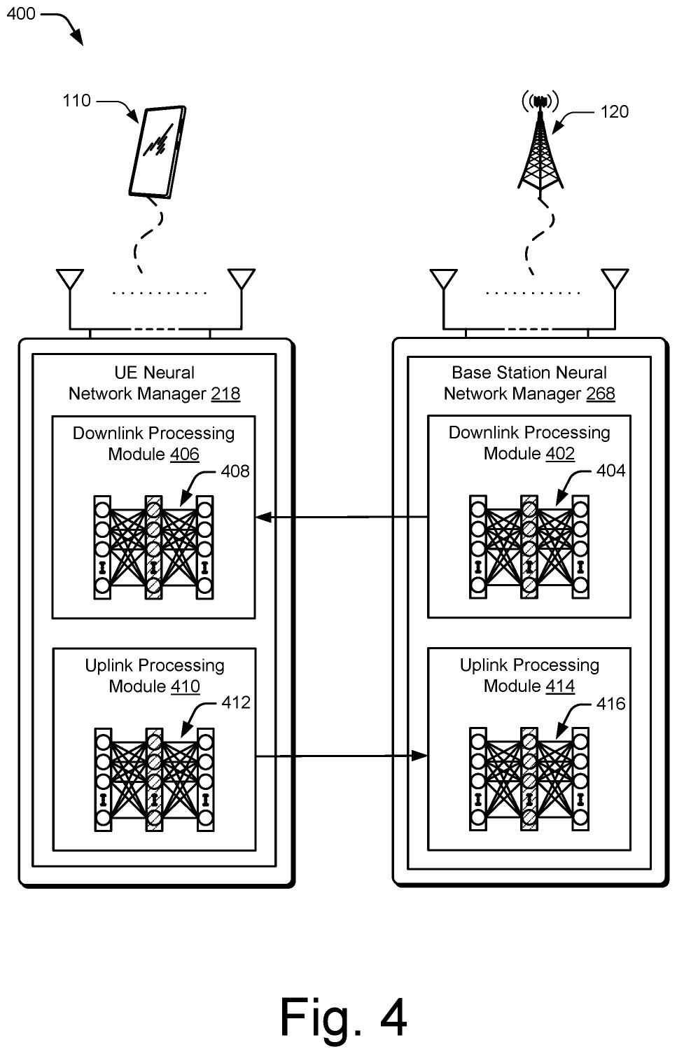

FIG. 4 illustrates an example operating environment 400 that includes the UE 110 and the base station 120 that can implement various aspects of federated learning for DNNs in a wireless communication system. In implementations, the UE 110 and base station 120 exchange communications with one another over a wireless communication system by processing the communications using multiple DNNs.

The base station neural network manager 268 of the base station 120 includes a downlink processing module 402 for processing downlink communications, such as for generating downlink communications transmitted to the UE 110. To illustrate, the base station neural network manager 268 forms deep neural network(s) 404 (DNNs 404) in the downlink processing module 402 using a complementary BS ML configuration to the common ML configuration used by a UE as further described. In aspects, the DNNs 404 perform some or all of a transmitter processing chain functionality used to generate downlink communications, such as a processing chain that receives input data, progresses to an encoding stage, followed by a modulating stage, and then a radio frequency (RF) analog transmit (Tx) stage. To illustrate, the DNNs 404 can perform convolutional encoding, serial-to-parallel conversion, cyclic prefix insertion, channel coding, time/frequency interleaving, and so forth.

Similarly, the UE neural network manager 218 of the UE 110 includes a downlink processing module 406, where the downlink processing module 406 includes deep neural network(s) 408 (DNNs 408) for processing (received) downlink communications. In aspects, the DNNs 408 perform some or all receiver processing functionality for (received) downlink communications, such as complementary processing to the processing performed by the DNNs 404 (e.g., an RF analog receive (Rx) stage, a demodulating stage, a decoding stage). To illustrate, the DNNs 408 can perform any combination of extracting data embedded on the Rx signal, recovering binary data, correcting for data errors based on forward error correction applied at the transmitter block, extracting payload from frames and/or slots, and so forth.

The base station 120 and/or the UE 110 also process uplink communications using DNNs. In environment 400, the UE neural network manager 218 includes an uplink processing module 410, where the uplink processing module 410 includes deep neural network(s) 412 (DNNs 412) for generating and/or processing uplink communications (e.g., encoding, modulating). In other words, the uplink processing module 410 processes pre-transmission communications as part of processing the uplink communications. The UE neural network manager 218, for example, forms the DNNs 412 using an ML configuration to perform some or all of the transmitter processing functionality used to generate uplink communications transmitted from the UE 110 to the base station 120.

Similarly, uplink processing module 414 of the base station 120 includes deep neural network(s) 416 (DNNs 416) for processing (received) uplink communications, where the base station neural network manager 268 forms DNNs 416 using a complementary (base station) ML configuration to perform some or all receiver processing functionality for (received) uplink communications, such as uplink communications received from the UE 110. Thus, the DNNs 412 and the DNNs 416 perform complementary functionality of one another.

Generally, a deep neural network (DNN) corresponds to groups of connected nodes that are organized into three or more layers. The nodes between layers are configurable in a variety of ways, such as a partially connected configuration where a first subset of nodes in a first layer are connected with a second subset of nodes in a second layer, or a fully connected configuration where each node in a first layer is connected to each node in a second layer, etc. The nodes can use a variety of algorithms and/or analysis to generate output information based upon adaptive learning, such as single linear regression, multiple linear regression, logistic regression, step-wise regression, binary classification, multiclass classification, multi-variate adaptive regression splines, locally estimated scatterplot smoothing, and so forth. At times, the algorithm(s) include weights and/or coefficients that change based on adaptive learning. Thus, the weights and/or coefficients reflect information learned by the neural network.

A neural network can also employ a variety of architectures that determine what nodes within the neural network are connected, how data is advanced and/or retained in the neural network, what weights and coefficients are used to process the input data, how the data is processed, and so forth. These various factors collectively describe an NN formation configuration. To illustrate, a recurrent neural network, such as a long short-term memory (LSTM) neural network, forms cycles between node connections in order to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that the NN formation configuration can include a variety of parameter configurations that influence how the neural network processes input data.

An NN formation configuration of a neural network can be characterized by various architecture and/or parameter configurations. To illustrate, consider an example in which the DNN implements a convolutional neural network. Generally, a convolutional neural network corresponds to a type of DNN in which the layers process data using convolutional operations to filter the input data. Accordingly, the convolutional NN formation configuration can be characterized with, by way of example and not of limitation, pooling parameter(s) (e.g., specifying pooling layers to reduce the dimensions of input data), kernel parameter(s) (e.g., a filter size and/or kernel type to use in processing input data), weights (e.g., biases used to classify input data), and/or layer parameter(s) (e.g., layer connections and/or layer types). While described in the context of pooling parameters, kernel parameters, weight parameters, and layer parameters, other parameter configurations can be used to form a DNN. Accordingly, an NN formation configuration can include any other type of parameter that can be applied to a DNN that influences how the DNN processes input data to generate output data.

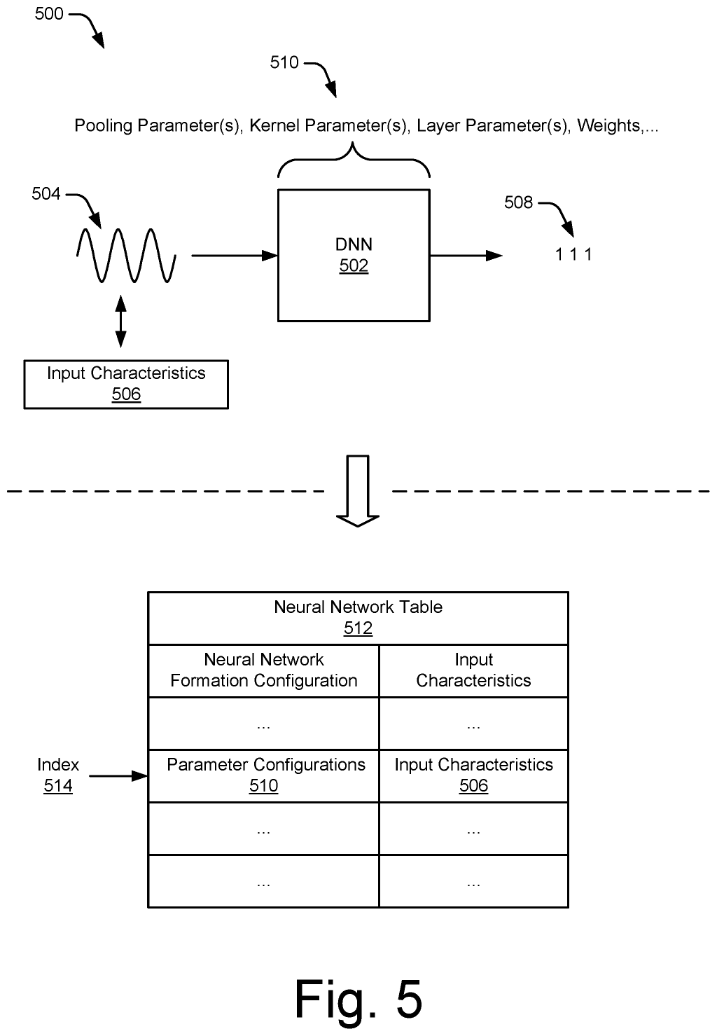

FIG. 5 illustrates an example 500 that describes aspects of generating multiple NN formation configurations in accordance with federated learning for DNNs in a wireless communication system. At times, various aspects of the example 500 are implemented by any combination of the UE federated learning manager 220, the UE neural network manager 218, the training module 222, and/or the base station neural network manager 268 of FIG. 2.

The upper portion of FIG. 5 includes a DNN 502 that represents any suitable DNN used to implement federated learning for DNNs in a wireless communication system. In implementations, a neural network manager determines to generate different NN formation configurations, such as NN formation configurations for processing wireless communications based on different UE locations, UE capabilities, and so forth. Alternatively, or additionally, the neural network generates NN formation configurations based on different transmission environments and/or transmission channel conditions. Training data 504 represents an example input to the DNN 502, such as data corresponding to a downlink communication and/or uplink communication with a particular operating configuration and/or a particular transmission environment. To illustrate, the training data 504 can include digital samples of a downlink wireless signal, recovered symbols, recovered frame data, binary data, etc. In some implementations, the training module generates the training data mathematically or accesses a file that stores the training data. Other times, the training module obtains real-world communications data. Thus, the training module can train the DNN 502 using mathematically generated data, static data, and/or real-world data. Some implementations generate input characteristics 506 that describe various qualities of the training data, such as an operating configuration, transmission channel metrics, UE capabilities, UE velocity, an estimated UE-location, and so forth.

The DNN 502 analyzes the training data and generates an output 508 represented here as binary data. Some implementations iteratively train the DNN 502 using the same set of training data and/or additional training data that has the same input characteristics to improve the accuracy of the machine-learning module. During training, the machine-learning module modifies some or all of the architecture and/or parameter configurations of a neural network included in the machine-learning module, such as node connections, coefficients, kernel sizes, etc. At some point in the training, the training module determines to extract the architecture and/or parameter configurations 510 of the neural network (e.g., pooling parameter(s), kernel parameter(s), layer parameter(s), weights), such as when the training module determines that the accuracy meets or exceeds a desired threshold, the training process meets or exceeds an iteration number, and so forth. The training module then extracts the architecture and/or parameter configurations from the machine-learning module to use as an NN formation configuration and/or NN formation configuration element(s). The architecture and/or parameter configurations can include any combination of fixed architecture and/or parameter configurations, and/or variable architectures and/or parameter configurations.

The lower portion of FIG. 5 includes a neural network table 512 that represents a collection of NN formation configuration elements, such as neural network table 216 or neural network table 274 of FIG. 2. The neural network table 512 stores various combinations of architecture configurations, parameter configurations, and input characteristics, but alternative implementations omit the input characteristics from the table. Various implementations update and/or maintain the NN formation configuration elements and/or the input characteristics as the DNN learns additional information. For example, at index 514, the neural network manager and/or the training module updates the neural network table 512 to include architecture and/or parameter configurations 510 generated by the DNN 502 while analyzing the training data 504. At a later point in time, the neural network manager selects one or more NN formation configurations from the neural network table 512 by matching the input characteristics to a current operating environment and/or configuration, such as by matching the input characteristics to current channel conditions, an estimated UE-location, UE capabilities, UE characteristics (e.g., velocity) and so forth.

Federated Learning for DNNs for a Wireless Communication System

Federated learning for an ML algorithm distributes training across multiple devices. In aspects, a managing entity distributes an initial ML algorithm to the multiple devices and aggregates the learned results (e.g., updated ML information) received from the multiple devices to determine an updated version of the initial ML algorithm. Because ML algorithms improve by processing more data and receiving feedback on the processing, distributing a common initial ML algorithm to multiple devices increases an amount of data processed by the initial ML algorithm and potentially improves the ML algorithm using the (aggregated) updates. Federated learning also protects the input data used by each device from potential exposure to the managing entity. Rather than communicating the input data to the managing entity, each device communicates updates to the ML algorithm, thus protecting the input data from potential exposure. In aspects of federated learning for DNNs for a wireless communication system, a network entity, such as a base station or core network, distributes an ML algorithm to a set of UEs and aggregates the individual ML training results to determine a common ML architecture suited to at least a subset of the UEs in the set.

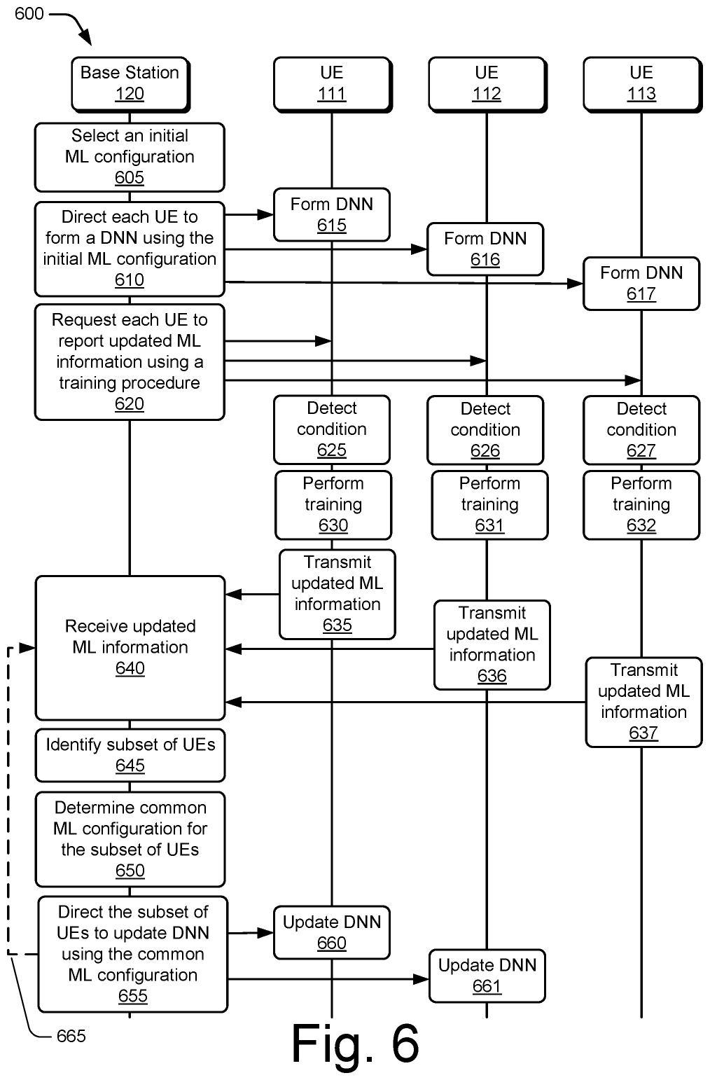

FIG. 6 illustrates an example signaling and control transaction diagram between a base station and a set of UEs in accordance with one or more aspects of federated learning for DNNs for a wireless communication system. Operations of the signaling and control transactions may be performed by the base station 120 of FIG. 1, the UE 111, the UE 112, and the UE 113 of FIG. 1, using aspects as described with reference to any of FIGS. 1-5. In alternative or additional aspects, at least some operations performed by the base station 120 can be performed by the core network 302 of FIG. 3 (not illustrated).

As illustrated, at 605, the base station 120 selects an initial ML configuration for a DNN that processes wireless network communications. As one example, the base station 120 obtains an estimated UE-location for each of the UEs 111, 112, and 113, and aggregates similar or commensurate estimated UE-locations (e.g., within a threshold value or range to one another), such as by generating an average estimated UE-location for UEs that are near each other. The base station 120 then selects the initial ML configuration using the aggregated estimated UE-location. To illustrate, the base station 120 accesses historical records that indicate previous ML configurations used by prior UEs at the aggregated estimated UE-location and selects or calculates the initial ML configuration using the historical ML configurations. Alternatively, or additionally, the base station 120 analyzes and/or aggregates UEs 111, 112, and 113 with similar signal or link quality parameters, and selects or calculates the initial ML configuration based on historical ML configurations with equivalent signal or link quality parameters. Sometimes the base station 120 selects a default ML configuration as the initial ML configuration or accesses a neural network table to select the initial ML configuration.

In aspects, the base station receives a UE capability information message (not illustrated) from each UE and selects the initial ML configuration based on a common UE capability between the UEs 111, 112, and 113. As one example, the UE capability information message includes ML capabilities (e.g., any one or more of: supported ML architectures, supported number of layers, available processing power, memory/storage capabilities, available power budget, fixed-point processing vs. floating-point processing, maximum kernel size capability, computation capability), and the base station 120 selects the initial ML configuration based on a common ML capability supported by the UEs 111, 112, and 113.

In some aspects, the base station 120 selects the set of UEs based on any combination of UE characteristics (e.g., UE capabilities, UE ML capabilities, estimated UE-location) and/or channel conditions (e.g., indicated by signal or link quality parameters). As one example, the base station 120 receives a respective geographic UE-location from a plurality of UEs, such as through a radio resource control (RRC) message or a Non-Access Stratum (NAS) message, and selects the set of UEs (e.g., UE 111, UE 112, and UE 113) based on the set of UEs residing within a predefined distance or range to one another. As another example, the base station 120 receives signal and/or link quality measurements through RRC messages and/or Media Access Control (MAC) layer messages and selects the set of UEs based on the UEs having commensurate (e.g., within a threshold value or range to one another) signal and/or link quality parameters.

The initial ML configuration sometimes forms a DNN that processes single-directional wireless communications, such as downlink wireless communications or uplink wireless communications as described with reference to FIG. 4. Alternatively, or additionally, the initial ML configuration processes bidirectional wireless communications (e.g., downlink and uplink communications). Thus, the base station 120 can select different ML configurations for different types of processing (e.g., transmitter chain operations, receiver chain operations). Alternatively, or additionally, the core network server 302 (not illustrated) selects the initial ML configuration and communicates the ML configuration UEs through base station 120.

At 610, the base station 120 directs each UE in a set of UEs (e.g., UE 111, UE 112, UE 113) to form a (respective) DNN using the initial ML configuration. To illustrate, the base station 120 transmits an indication of an index value of a neural network table to the UEs 111, 112, and 113. In aspects, the base station 120 transmits the indication over a control channel using layer 1 signaling and/or layer 2 messaging. In some aspects, the base station 120 transmits the indication using an RRC message or a NAS message.

At 615, 616, and 617, the UEs 111, 112, and 113, respectively, receive the directions to form the DNN and then form the DNN using the initial ML configuration. For instance, each UE accesses a respective UE-stored neural network table (e.g., neural network table 216) using the indicated index to obtain an NN formation configuration that specifies an ML architecture and/or ML parameters as described with reference to FIG. 5. The UEs 111, 112, and 113 then each form their own DNN using the ML architecture and/or ML parameters and process the wireless network communications using the DNN.

At 620, the base station 120 requests each UE in the set of UEs (e.g., UE 111, UE 112, and UE 113) to report updated ML information generated using a training procedure and input data local to the respective UE. To illustrate, the base station 120 transmits the request using an RRC message or a NAS message. In aspects, the base station 120 implicitly and/or explicitly requests each UE to report the updated ML information. To illustrate, the base station implicitly requests the UE to report the updated ML information (and/or to perform the training procedure) by indicating one or more update conditions that specify rules or instructions on when to report the updated ML information. Alternatively, or additionally, the base station 120 explicitly requests each UE to report the updated ML information using a flag in a message, through an RRC message, or a NAS message.

In aspects, the base station 120 directs each UE to perform an online training procedure, such as an online training procedure that trains the DNNs while processing the wireless network communications. In other aspects, the base station 120 directs each UE to perform an offline training procedure that uses stored data and while the DNN is not processing the wireless network communications. Thus, in some aspects, the base station 120 directs the set of UEs on when to perform the federated training procedure and/or whether to perform online or offline training, such as by transmitting an RRC message or a NAS message to each UE in the set of UEs.

As one example of an update condition, the base station 120 requests each UE in the set of UEs to transmit updated ML information (and/or to perform the training procedure) periodically and indicates a recurrence time interval. As another example update condition, the base station 120 requests each UE in the set of UEs to transmit the updated ML information (and/or to perform the training procedure) in response to detecting a trigger event, such as trigger events that correspond to changes in a DNN at a UE. To illustrate, the base station 120 requests each UE to transmit updated ML information when the UE determines that an ML parameter (e.g., a weight or coefficient) has changed more than a threshold value. As another example, the base station 120 requests that each UE transmits updated ML information in response to detecting when the DNN architecture changes at the UE, such as when a UE identifies (by way of the UE neural network manager 218 and/or the UE federated learning manager 220) that the DNN has changed the ML architecture by adding or removing a node or layer. In aspects, the base station 120 implicitly or explicitly indicates to perform an offline training procedure to obtain the updated ML information, while in other aspects, the base station 120 implicitly or explicitly indicates to perform an online training procedure.

In some aspects, the base station 120 requests the UEs to report updated ML information based on UE-observed signal or link quality parameters. To illustrate, the base station 120 requests, as a trigger event and/or update condition, that the UE report updated ML information in response to identifying that a downlink signal and/or link quality parameter (e.g., RSSI, SINR, CQI, channel delay spread, Doppler spread) has changed by, or meets, a threshold value. As another example, the base station 120 requests, as a trigger event and/or update condition, that the UE report updated ML information in response to detecting a threshold value of acknowledgments/negative-acknowledgments (ACKs/NACKs). Thus, the base station 120 can request synchronized updates (e.g., periodic) from the set of UEs or asynchronous updates from the set of UEs based on conditions detected at the respective UE. In aspects, the base station requests the UE report observed signal or link quality parameters along with the updated ML information.

At 625, at 626, and at 627, the UEs 111, 112, and 113 (respectively) detect at least one of the update conditions indicated at 620. In aspects, the UE 111, 112, and/or 113 detect the occurrence of the update conditions by way of the UE federated learning manager 220. To illustrate, the UE 111, the UE 112, and/or the UE 113 each set a timer in response to receiving the recurrence time duration and detect expiration of the timer. As another example, the UE 111, the UE 112, and/or the UE 113 determine that an ML parameter has changed more than a first threshold value by periodically comparing the ML parameter to the first threshold value, that the DNN architecture has changed through a reconfiguration request, or that a signal or link quality parameter has changed by a second threshold value by comparing the quality parameters to the second threshold value (or a difference from a prior value) each time the quality parameters are generated.

At 630, at 631, and at 632, the UEs 111, 112, and 113 optionally perform a training procedure to generate the updated ML information. To illustrate, the UEs 111, 112, and 113 optionally perform an offline training procedure or an online training procedure by providing feedback to the ML algorithm initially formed at 615, 616, 617 when processing the wireless network communications. Alternatively, or additionally, the UEs 111, 112, and 113 continuously perform the online training procedure by continuously providing the feedback to the ML algorithm while processing the wireless network communications and continuously generate the updated ML information.

In response to detecting the condition and/or in response to performing a training procedure, at 635, 636, and/or 637, the UEs 111, 112, and 113 transmit a message that indicates updated ML information to the base station 120. As one example, the UEs 111, 112, and 113 transmit a message that indicates an index into a neural network table or transmit an indication of ML parameters and/or ML architectures. In some aspects, the UEs 111, 112, and 113 transmit signal and/or link quality parameters along with the updated ML information.

Accordingly, at 640, the base station 120 receives updated ML information from at least some of the UEs, where the updated ML information can indicate any combination of ML parameters, ML architectures, and/or ML gradients. As one example, the UEs send an indication of an index into a neural network table or transmit an indication of ML parameters, ML architectures, and/or ML gradients. In some aspects, the base station 120 receives signal and/or link quality parameters with the updated ML information. The base station 120 receives the updated ML information using any suitable mechanism, such as an NAS message that indicates an index to a neural network table, where the neural network table can include absolute and/or delta ML configurations, or NAS messages that indicate full or absolute ML configurations. For clarity, the diagram 600 shows the condition detections and updated ML information transmissions at each UE occurring contemporaneously, but the timing and occurrence of the detections and transmissions can occur asynchronously from one another.

At 645, the base station 120 identifies a subset of UEs from the set of UEs. Alternatively, or additionally, the core network server 302 (not illustrated) identifies the subset of UEs based on one or more common characteristics. As one example, the base station 120 selects the subset of UEs based on common UE capabilities, such as a common number of antennas or common transceiver capabilities. Alternatively, or additionally, the base station 120 selects the subset of UEs based on commensurate signal or link quality parameters that are within a threshold value relative to one another. This can include commensurate uplink and/or downlink signal quality parameters (e.g., RSRP, SINR, CQI, MCS). To illustrate, based on any combination of common UE capabilities, commensurate signal or link quality parameters, commensurate updated ML information (e.g., common ML architecture updates, ML parameter updates within a threshold value), estimated UE-location (e.g., within a predetermined distance between UEs), and so forth, the base station 120 determines to include the UE 111 and the UE 112 in the subset of UEs and omit the UE 113 from the subset of UEs. In some implementations, the core network server 302 (not illustrated) identifies the subset of UEs based on one or more common or commensurate characteristics and communicates the subset of UEs to the base station 120. In aspects, the subset of UEs includes at least two UEs.

At 650, the base station 120 determines a common ML configuration for the subset of UEs. In determining the common ML configuration, the base station 120 applies federated learning techniques that aggregate the updated ML information received from multiple UEs (e.g., updated ML information transmitted at 635, 636, and/or 637) without potentially exposing private data used at the UE to generate the updated ML information. As one example, the base station 120 performs averaging that aggregates ML parameters, gradients, and so forth. In alternative or additional implementations, the core network server 302 (not illustrated) determines the common ML configuration using federated learning techniques. In aspects, the base station determines a common ML configuration that indicates a (delta) update to the initial ML configuration used by the subset of UEs, or a common ML configuration that indicates an (absolute) ML configuration that forms a new DNN.

In some aspects, the base station 120 determines a first common ML configuration for forming DNNs at the UE 111 and the UE 112 and a second common ML configuration for forming a complementary DNN at the base station 120. As one example, each UE in the subset of UEs uses the first common ML configuration to form a receiver DNN for processing received downlink communications, such as DNN 408 of FIG. 4, and the base station 120 uses the second common ML configuration to form a DNN (e.g., DNN 412) for generating downlink communications transmitted to the UEs in the subset of UEs. However, the first and second common configurations can alternatively or additionally form uplink DNNs (e.g., DNN 412, DNN 416). In some aspects, the base station 120 analyzes a neural network table to identify the common ML configuration as further described.

At 655, the base station 120 directs the subset of UEs to update the DNN formed at 615 and at 616 using the common ML configuration determined at 650. To illustrate, the base station 120 transmits an indication of an index value into a neural network table, where the index value maps to an entry that specifies the ML configuration of the common ML configuration. To illustrate, the base station transmits the indication using a NAS message that indicates an index to a neural network table that includes absolute and/or delta ML configurations or NAS messages that indicate full or absolute ML parameters and/or architectures. The subset of UEs (e.g., UE 111 and UE 112) then update their respective DNNs using the common ML configuration at 660 and at 661, such as by accessing a local neural network table and extracting the common ML configuration.

At 665, the signaling and control transaction diagram optionally returns from directing the subset of UEs to update a DNN to receiving updated ML information at 640. In aspects, the base station 120 receives the additional updated ML information from any combination of UEs in the set of UEs (e.g., UE 11, UE 112, UE 113). The base station 120 analyzes the updated ML information and, at times, identifies a new subset of UEs and/or a new common ML configuration for the subset of UEs (e.g., UE 111 and UE 112). This allows the base station 120 to analyze updated ML information and adapt the common DNN to optimize (and re-optimize and/or iteratively optimize) the processing as the operating environment changes (e.g., changing channel conditions, changing UE-locations). The distributed learning provides the base station 120 (or core network server 302) with larger quantities of learned DNN configurations and improves how the base station 120 selects the common ML configuration to improve an overall performance (e.g., higher processing resolution, faster processing, fewer bit errors, improved signal quality, reduced latency) of the corresponding DNNs processing the wireless communications.

Example Methods

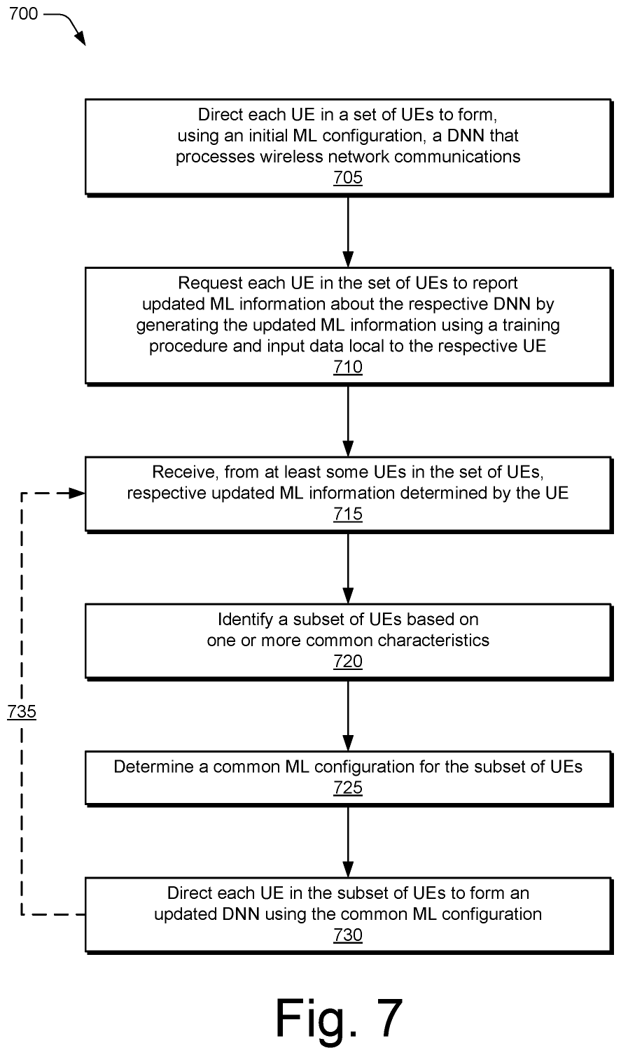

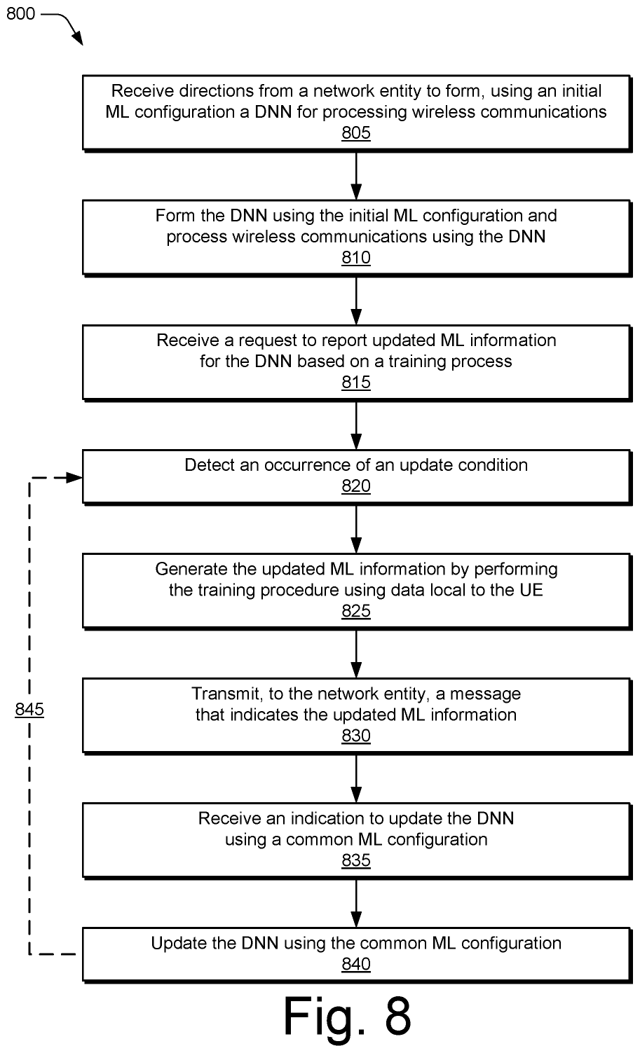

Example methods 700 and 800 are described with reference to FIG. 7 and FIG. 8 in accordance with one or more aspects of federated learning for DNNs for a wireless communication system. FIG. 7 illustrates an example method 700 used to perform aspects of federated learning for DNNs for a wireless communication system as performed by a network entity, such as the base station 120 and/or the core network server 302.

At 705, a network entity directs each UE in a set of UEs to form, using an initial ML configuration, a DNN that processes wireless network communications. For example, the base station 120 directs the set of UEs (e.g., UE 111, UE 112, UE 113) to form the DNN using the initial ML configuration as described at 610 of FIG. 6. In some aspects, the core network server 302 determines the initial ML configuration and directs, through the base station 120, the set of UEs to form the DNN. The base station 120 and/or the core network server 302 determines the initial ML configuration using any combination of characteristics, such as estimated UE-locations, signal or link quality parameters, or UE capabilities. In aspects, to direct the UEs to form the DNN, the base station 120 transmits an indication of an index value in a neural network table stored at each UEs in the set of UEs. In some aspects, the base station 120 receives UE characteristics, such as UE capabilities, UE ML capabilities, or geographic locations, and forms the set of UEs based on the UE characteristics.

At 710, the network entity requests each UE in the set of UEs to report updated ML information about the respective DNN by generating the updated ML information using a training procedure and input data local to the UE. In some aspects, the network entity explicitly requests the UE to report the updated ML information (and/or to perform the training procedure), such as by using a flag in a message, an RRC message, or a NAS message. Alternatively, or additionally, the network entity implicitly requests the updated ML information (and/or to perform the training procedure), such as by communicating one or more update conditions to each UE in the set of UEs, where the update conditions specify rules or instructions on when to report the updated ML information. For example, as described at 620 of FIG. 6, the base station 120 specifies a recurrence time duration that indicates to report the updated ML information periodically or indicates a trigger event that specifies to report the updated ML information in response to detecting the trigger event. Alternatively, or additionally, the core network server 302 requests, from each UE, the updated ML information through the base station. In some aspects, the base station 120 implicitly or explicitly instructs each UE, as part of indicating to report the updated ML information, to perform an offline or online training procedure in response to detecting the one or more update conditions.

At 715, the network entity receives, from at least some UEs in the set of UEs, respective updated ML information determined by the UE. To illustrate, the base station 120 receives any combination of ML parameter updates (e.g., weights, coefficients), ML architecture updates (e.g., the addition or removal of nodes or layers), or gradient updates as described at 640 of FIG. 6.

At 720, the network entity identifies a subset of UEs based on one or more common characteristics. For example, as described at 645 of FIG. 6, the base station 120 identifies the subset of UEs using any combination of common UE capabilities, common signal or link quality parameters, or an estimated UE-location. Alternatively, or additionally, the core network server 302 identifies the subset of UEs by way of the core network federated learning manager 314 and/or the core network neural network manager 312. In aspects, the subset of UEs includes at least two UEs.

At 725, the network entity determines a common ML configuration for the subset of UEs. To illustrate, the base station 120 aggregates the updated ML information from the subset of UEs and determines the common ML configuration based on the aggregated results as described at 650 of FIG. 6. For instance, the base station 120 averages DNN coefficient updates from the subset of UEs and selects a common ML configuration from a neural network table using the averaged results. Alternatively, or additionally, the core network server 302 determines the common ML configuration by way of the core network federated learning manager 314 and/or the core network neural network manager 312.

At 730, the network entity directs each UE in the subset of UEs to form an updated DNN using the common ML configuration. For example, the base station 120 directs the subset of UEs (e.g., UE 111, UE 112) to update the DNN (formed using the initial ML configuration indicated at 705) using the common ML configuration as described at 655.

In some aspects, the method 700 iteratively repeats as indicated at 735. For instance, the base station receives additional updated ML information from the subset of UEs (e.g., UE 111, UE 112) and/or other UEs omitted from the subset (e.g., UE 113). In response to receiving the additional updated ML information, the base station determines to select a new subset of UEs, select a new common ML configuration, or any combination thereof. This iterative process allows the network entity to dynamically adapt DNNs using federated learning from multiple DNNs, and improve how the DNNs process wireless communications, to optimize (and re-optimize) the processing as conditions change.

FIG. 8 illustrates an example method 800 used to perform aspects of federated learning for DNNs for a wireless communication system as performed by a network entity, such as the UE 110.

At 805, the UE receives, from a network entity, an initial ML configuration for a DNN that processes wireless communications at the UE. For example, the UE 110 receives an indication of the initial ML configuration from the base station 120 as described at 615, 616, and 617 of FIG. 6. To illustrate, the UE 110 receives an indication of an index value into a neural network table.

At 810, the UE forms the DNN using the initial ML configuration and processes wireless communications using the DNN. To illustrate, with reference to FIG. 6, the UE 111 forms the DNN and processes wireless communications as described at 615, the UE 112 forms the DNN and processes wireless communications as described at 616, and the UE 113 forms the DNN and processes wireless communications as described at 617.

At 815, the UE receives a request for updated machine-learning (ML) information for the DNN. Alternatively, or additionally, the UE receives an update condition that specifies rules or instructions on when to report the updated ML information to a network entity. For example, the UE 110 receives a recurrence time duration that specifies to transmit the updated ML information periodically based on the recurrence time duration as described at 620 of FIG. 6.

At 820, the UE detects an occurrence of the update condition. To illustrate, the UE 110 sets a timer in response to receiving the recurrence time duration and detects expiration of the timer as described at 625, at 626, and at 627 of FIG. 6. As another example, the UE 110 determines that a signal or link quality parameter has changed a threshold value amount. As yet another example, the UE 110 determines that a UE-location has changed more than a threshold value amount.

At 825, the UE performs a training procedure using data local to the UE. To illustrate, as described at 630, at 631, and at 632 of FIG. 6, the UE optionally performs an offline training procedure or performs an online training procedure by providing feedback to the ML algorithm while processing the wireless network communications.

At 830, the UE transmits a message that indicates the updated ML information to the network entity. For example, the UE 110 transmits the message that indicates the updated ML configuration as described at 635, at 636, and at 637 of FIG. 6. In some aspects, the UE 110 transmits signal and/or link quality parameters with the updated ML information.

At 835, the UE receives a second indication that directs the UE to update the DNN using a common ML configuration. To illustrate, as described at 680 of FIG. 6, the UE 110 receives an indication from the base station 120 to update the DNN using the common ML configuration, such as by receiving an indication of an index value into a neural network table. At 840, the UE updates the DNN using the common ML configuration. For instance, as described at 685 and at 690 of FIG. 6, the UE 110 updates the DNN based on the common ML configuration, such as by obtaining an ML configuration from a neural network table and updating the DNN using the obtained ML configuration.

In some aspects, the method 800 iteratively repeats as indicated at 845. For instance, the UE 110 detects a second occurrence of the update condition or a first occurrence of another update condition and transmits updated ML information to the network entity (e.g., the base station 120, the core network server 302). In response to transmitting the updated ML information, the UE 110 sometimes receives additional indications of updates to the DNNs. This iterative process allows the UE to communicate updated ML information to a network entity and indications of new ML configurations based on distributed learning with other UEs that optimize (and re-optimize) the DNN processing the wireless communications as conditions change.

The order in which the method blocks of the method 700 and the method 800 are described is not intended to be construed as a limitation, and any number of the described method blocks can be skipped or combined in any order to implement a method or an alternative method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or additionally, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

In the following, several examples are described:

Example 1: A method performed by a network entity for determining at least one machine-learning (ML) configuration using distributed training in a wireless network, the method comprising: directing each user equipment (UE) in a set of user equipments (UEs) to form, using an initial ML configuration, a respective deep neural network (DNN) that processes wireless network communications; requesting, from each UE in the set of UEs, a report of updated ML information about the respective DNN of the UE by generating the updated ML information using a training procedure and input data local to the UE; receiving, from at least some UEs in the set of UEs, respective updated ML information determined by the UE; identifying a subset of UEs in the set of UEs with one or more common characteristics; determining, using the respective updated ML information from each UE in the subset of UEs, a common ML configuration; and directing each UE in the subset of UEs to form an updated DNN that processes the wireless network communications using the common ML configuration.

Example 2: The method as recited in example 1, wherein requesting the report of updated ML information further comprises: implicitly requesting the report of updated ML information by indicating one or more update conditions that specify when to report the updated ML information.

Example 3: The method as recited in example 2, wherein the one or more update conditions comprise at least one of: a recurrence time duration; or a trigger event.

Example 4: The method as recited in example 3, wherein the one or more update conditions comprises the trigger event, and wherein the trigger event comprises: one or more DNN parameters of the DNN changing by more than a first threshold value; a DNN architecture of the DNN changing; a first signal or link quality parameter changing by more than a second threshold value; or a UE-location changing by at least a third threshold value.

Example 5: The method as recited in example 4, wherein the trigger event comprises the first signal or link quality parameter changing by more than the second threshold value, and wherein the first signal or link quality parameter comprises: received signal strength indicator, RSSI; reference signal receive quality, RSRQ; reference signal receive power, RSRP; signal-to-interference-plus-noise ratio, SINR; channel quality indicator, CQI, channel delay spread; or Doppler spread.

Example 6: The method as recited in any one preceding example, wherein receiving respective updated ML information comprises: receiving, from the at least some UEs in the set of UEs, respective signal or link quality parameters, and wherein determining the common ML configuration further comprises: determining the common ML configuration based on the respective signal or link quality parameters.

Example 7: The method as recited in example 6, wherein determining the common ML configuration based on the respective signal or link quality parameters further comprises: determining the common ML configuration using commensurate signal or link quality parameters from the at least some UEs in the set of UEs.

Example 8: The method as recited in any one preceding example, wherein identifying the subset of UEs in the set of UEs comprises: selecting at least two UEs, from the set of UEs, with one or more: common UE capabilities; commensurate signal or link quality parameters; or commensurate UE-locations.

Example 9: The method as recited in example 8, wherein the commensurate signal or link quality parameters comprise: uplink signal or link quality parameters; or downlink signal or link quality parameters.

Example 10: The method as recited in any one preceding example, wherein determining the common ML configuration further comprises: determining at least one of: a common ML architecture; or one or more common ML parameters.

Example 11: The method as recited in any one preceding example, wherein determining the common ML configuration further comprises: determining the common ML configuration for a downlink DNN that processes downlink wireless communications; or determining the common ML configuration for an uplink DNN that processes uplink wireless communications.

Example 12: The method as recited in example 11, wherein determining the common ML configuration further comprises: determining the common ML configuration for the uplink DNN, and wherein the method further comprises: updating, at the network entity and based on the common ML configuration for the uplink DNN, a receive ML architecture that forms a receive DNN (RX DNN) at the network entity for processing the uplink wireless communications.

Example 13: The method as recited in any one of the preceding examples, wherein directing each UE in the subset of UEs to form the updated DNN using the common ML configuration comprises: transmitting, to each UE in the subset of UEs, an indication of the direction using layer 1 signaling or layer 2 messaging.

Example 14: The method as recited in any one preceding example, wherein receiving the respective updated ML information further comprises: receiving at least one of: an ML parameter; or an ML architecture.

Example 15: The method as recited in any one preceding example, further comprising: receiving UE characteristics from the at least some UEs; and selecting the set of UEs from a plurality of UEs based on one or more common UE characteristics.

Example 16: The method as recited in any one of the preceding examples, wherein directing each UE in the subset of UEs to form an updated DNN comprises: transmitting, to each UE in the subset of UEs, a first index value that maps to a first entry in a neural network table.

Example 17: The method as recited in example 16, wherein the first index value that maps to the first entry in the neural network table maps to an absolute ML configuration in the neural network table, or maps to a delta ML configuration in the neural network table.

Example 18: The method as recited in any one of the preceding examples, wherein directing each UE in the set of UEs to form the respective DNN using the initial ML configuration further comprises: transmitting, to each UE in the subset of UEs, a second index value that maps to a second entry in a neural network table.

Example 19: The method as recited in example 18, wherein the second index value that maps to the second entry in the neural network table maps to an absolute ML configuration in the neural network table, or maps to a delta ML configuration in the neural network table.

Example 20: A network entity comprising: a processor; and computer-readable storage media comprising instructions, responsive to execution by the processor, for directing the network entity to perform one of the methods of examples 1 to 19.

Example 21: A method performed by a user equipment (UE) for participating in distributed training of a machine-learning (ML) algorithm in a wireless network, the method comprising: receiving directions from a network entity to form, using an initial ML configuration, a deep neural network (DNN) that processes wireless network communications; receiving, from a network entity, a request to report updated ML information for the DNN based on a training process; generating the updated ML information by performing the training process using data local to the UE; transmitting, to the network entity, a message that indicates the updated ML information; receiving, from the network entity, an indication to update the DNN using a common ML configuration; and updating the DNN using the common ML configuration.

Example 22: The method as recited in example 21, wherein performing the training process comprising: performing an offline training procedure or an online training procedure.

Example 23: The method as recited in example 21 or example 22, wherein receiving the request to report the updated ML information further comprises: receiving the request to report the updated ML information implicitly by receiving an update condition that specifies instructions on when to report the updated ML information.

Example 24. The method as recited in example 23, further comprising: performing the training procedure in response to detecting the update condition.

Example 25: The method as recited in example 23 or example 24, wherein the update condition comprises: a recurrence time duration for periodic updates; or a trigger event.

Example 26: The method as recited in example 24, wherein the update condition comprises the trigger event, and wherein the trigger event comprises at least one of: one or more DNN parameters of the DNN changing by more than a first threshold value; a DNN architecture of the DNN changing; a first signal or link quality parameter changing by more than a second threshold value; or a UE-location changing by at least a third threshold value.

Example 27: The method as recited in any one of examples 21 to 26, wherein the DNN that processes the wireless network communications comprises: a downlink DNN that processes downlink wireless communications; or an uplink DNN that processes uplink wireless communications.

Example 28: The method as recited in any one of examples 21 to 27, further comprising: transmitting, to the network entity, information usable by the network entity to select a subset of UEs for participating in the distributed training of the ML algorithm.

Example 29: The method as recited in example 28, wherein the information usable by the network entity to select the subset of UEs comprises at least one of: an estimated UE-location; a signal or link quality parameter; a UE capability; or a UE ML capability.

Example 30: The method as recited in example 28 or example 29, further comprising: including the information in the message that indicates the updated ML information.

Example 31: The method as recited in any one of examples 21 to 30, wherein the common ML configuration comprises: an absolute ML configuration; or a delta ML configuration based on the initial ML configuration.

Example 32: A user equipment comprising: a processor; and computer-readable storage media comprising instructions, responsive to execution by the processor, for directing the user equipment to perform one of the methods of examples 21 to 31.

Example 33: A computer-readable storage media comprising instructions that, responsive to execution by a processor, cause a method as recited in any one of examples 1 to 19 or 21 to 31 to be performed.

What is claimed is:

1. A method performed by a network entity for determining at least one machine-learning (ML) configuration using distributed training in a wireless network, the method comprising:
directing each user equipment (UE) in a set of user equipments (UEs) to form, using an initial ML configuration, a respective deep neural network (DNN) that processes wireless network communications, each DNN performing some or all of a transmitter and/or receiver processing chain functionality;
requesting, from each UE in the set of UEs, a report of updated ML information about the respective DNN of the UE, the updated ML information generated by the UE using a training procedure and input data local to the UE;
receiving, from at least some UEs in the set of UEs, respective updated ML information determined by the UE and one or more respective link or signal quality parameters;
identifying, by using the one or more respective link or quality parameters, a subset of UEs in the set of UEs with one or more commensurate link or signal quality parameters, the subset of UEs having one or more common characteristics or common channel conditions;
determining, using the respective updated ML information from each UE in the subset of UEs, a common ML configuration; and
directing each UE in the subset of UEs to form an updated DNN that processes the wireless network communications using the common ML configuration.

2. The method as recited in claim 1, further comprising:
determining, at the network entity and based on the common ML configuration, a complementary ML architecture for a network-side DNN at the network entity that performs complementary processing of the wireless network communications to processing performed by the updated DNN.

3. The method as recited in claim 1, wherein determining the common ML configuration further comprises:
determining the common ML configuration based on the one or more commensurate link or signal quality parameters.

4. The method as recited in claim 3, wherein determining the common ML configuration based on the one or more commensurate link or signal quality parameters further comprises at least one of:
determining the common ML configuration using uplink link or signal quality parameters generated by the network entity; or
determining the common ML configuration using downlink link or signal quality parameters received from one or more UEs in the set of UEs.

5. The method as recited in claim 1, wherein identifying the subset of UEs in the set of UEs further comprises:
selecting at least two UEs, from the set of UEs, with commensurate UE-locations.

6. The method as recited in claim 1, wherein determining the common ML configuration further comprises:
determining the common ML configuration for a downlink DNN that processes downlink wireless communications; or
determining the common ML configuration for an uplink DNN that processes uplink wireless communications.

7. The method as recited in claim 1, wherein requesting the report of updated ML information includes indicating one or more update conditions that specify when to report the updated ML information, the one or more update conditions comprising at least one of:
a first signal or link quality parameter changing by more than a first threshold value; or a UE-location changing by at least a second threshold value.

8. The method as recited in claim 7, further comprising:
indicating, to each UE in the set of UEs, to report the updated ML information based on the first signal or link quality parameter changing by more than the first threshold value, the first signal or link quality parameter comprising:
received signal strength indicator, RSSI;
reference signal receive quality, RSRQ;
reference signal receive power, RSRP;
signal-to-interference-plus-noise ratio, SINR;
channel quality indicator, CQI;
a number of acknowledgements/negative-acknowledgements, ACK/NACKs;
channel delay spread; or
Doppler spread.

9. A method performed by a user equipment (UE) for participating in distributed training of a machine-learning (ML) algorithm in a wireless network, the method comprising:
receiving directions from a network entity to form, using an initial ML configuration, a deep neural network (DNN) that processes wireless network communications, the DNN performing some or all of a transmitter and/or receiver processing chain functionality;
receiving, from the network entity, a request to report updated ML information for the DNN based on a training process;
generating the updated ML information by performing the training process using data local to the UE;
transmitting, to the network entity, a first indication of the updated ML information and one or more signal or link quality parameters observed by the UE as part of generating the updated ML information;
receiving, from the network entity, a second indication to update the DNN using a common ML configuration; and
updating the DNN using the common ML configuration.

10. The method as recited in claim 9, wherein receiving the request to report the updated ML information further comprises:
receiving instructions to report the updated ML information in response to detecting an update condition, the update condition comprising at least one of:
a first signal or link quality parameter changing by more than a first threshold value; or a UE-location changing by at least a second threshold value.

11. The method as recited in claim 10, further comprising:
detecting the update condition; and
performing an online training procedure or an offline training procedure in response to detecting the update condition.

12. The method as recited in claim 11, wherein detecting the update condition comprises:
detecting that the first signal or link quality parameter has changed by more than the first threshold value, the first signal or link quality parameter comprising:
received signal strength indicator, RSSI;
reference signal receive quality, RSRQ;
reference signal receive power, RSRP;
signal-to-interference-plus-noise ratio, SINR;
channel quality indicator, CQI;
a number of acknowledgements/negative-acknowledgements, ACK/NACKs; channel delay spread; or
Doppler spread.

13. The method as recited in claim 9, further comprising: transmitting, to the network entity, information usable by the network entity to select a subset of UEs for participating in the distributed training of the ML algorithm, the subset of UEs having one or more common characteristics or common channel conditions, the information comprising at least one of:
an estimated UE-location; or a UE ML capability.

14. The method as recited in claim 13, further comprising:
transmitting the information with the first indication.

15. A user equipment (UE) comprising a wireless transceiver;
a processor; and
computer-readable storage media comprising instructions, responsive to execution by the processor, cause the UE to:
receive directions from a network entity to form, using an initial ML configuration, a deep neural network (DNN) that processes wireless network communications, the DNN performing some or all of a transmitter and/or receiver processing chain functionality;
receive, from a network entity, a request to report updated machine-learning (ML) information for a deep neural network (DNN) based on a training process;
generate the updated ML information by performing the training process using data local to the UE;
transmit, to the network entity, a first indication of the updated ML information and one or more signal or link quality parameters observed by the UE as part of generating the updated ML information;
receive, from the network entity, a second indication to update the DNN using a common ML configuration; and
update the DNN using the common ML configuration.

16. The UE as recited in claim 15, wherein to receive the request to report the updated ML information, cause the UE to:
receive instructions to report the updated ML information in response to detecting an update condition, the update condition comprising at least one of:
a first signal or link quality parameter changing by more than a first threshold value; or
a UE-location changing by at least a second threshold value.

17. The UE as recited in claim 16, wherein the instructions, responsive to execution by the processor, cause the UE to:
to detect the update condition; and
perform an online training procedure or an offline training procedure in response to detecting the update condition.

18. The UE as recited in claim 17, wherein to detect the update condition, the UE to:
detect that the first signal or link quality parameter has changed by more than the first threshold value, the first signal or link quality parameter comprising:
received signal strength indicator, RSSI;
reference signal receive quality, RSRQ;
reference signal receive power, RSRP;
signal-to-interference-plus-noise ratio, SINR;
channel quality indicator, CQI;
a number of acknowledgements/negative-acknowledgements, ACK/NACKs;
channel delay spread; or
Doppler spread.

19. The UE as recited in claim 15, wherein the instructions, responsive to execution by the processor, cause the UE to:
transmit, to the network entity, information usable by the network entity to select a subset of UEs for participating in a distributed training of a ML algorithm, the subset of UEs having one or more common characteristics or common channel conditions, the information comprising at least one of:
an estimated UE-location; or a UE ML capability.

20. The UE as recited in claim 19, wherein the instructions, responsive to execution by the processor, cause the UE to: transmit the information with the first indication.
